(19) United States
(12) Patent Application Publication
(10) Pub. No.: US 2007/0201971 A1
(43) Pub. Date: Aug. 30, 2007

(54) Loading Device, Method For Loading And Auxiliary Transport Means

(76) Inventor: Sjoerd Meijer, St. Jacobiparochie (NL)

Correspondence Address: HARNESS, DICKEY & PIERCE, P.L.C., P.O. BOX 8910, RESTON, VA, 20195, US

(21) Appl. No.: 10/580,717

(22) PCT Filed: Nov. 26, 2004
(86) PCT No.: PCT/NL04/00823

§ 371 Date: Apr. 9, 2007

(30) Foreign Application Priority Data
Nov. 26, 2003 (NL) 1024885

(51) Int. Cl. B65G 69/00

(52) U.S. Cl. 414/679

(57) ABSTRACT

A loading device is disclosed for transferring a cargo onto a mobile loading floor. The loading device includes a frame having a carrying surface wherein the carrying surface has a longitudinal direction and wherein the frame is also provided with a support device for supporting the loading device on a ground surface. The loading device is provided with an adjusting device for aligning an outer end in the longitudinal direction of the carrying surface. An auxiliary transport device is further disclosed for loading and unloading cargo in a vehicle.

The invention relates to a loading device for transferring a cargo onto a mobile loading floor, such as for instance of a vehicle, comprising a frame having a carrying surface wherein the carrying surface has a longitudinal direction and wherein the frame is also provided with support means for supporting the loading device on a ground surface. The invention also relates to auxiliary transport means for transferring cargo onto a mobile loading floor, and to a method for transferring cargo.

It is known to support loads by means of a pallet, which pallet provides space for arranging forks of for instance a fork-lift truck for the purpose of lifting and displacing this load. During displacement the pallet takes up effective space which is not used by the load. The pallet must also be returned after transport.

Known from U.S. Pat. No. 4,355,940 is an automatic loading platform wherein use is made of a rigid frame provided with a double roller device, with which loads can be transported in and out of a loading space without support by means of a pallet.

The object of the present invention is to improve the transfer of cargoes, wherein no use is made of a pallet. According to a further aspect, the object of the invention is to provide an improved method of loading and unloading a mobile loading space, such as that of a vehicle.

This object is achieved according to the invention in that the loading device is provided with adjusting means for aligning the carrying surface, such as preferably the outer end of this carrying surface, in the longitudinal direction. The carrying surface can hereby be aligned with another surface, such as the mobile loading floor of for instance a vehicle. The orientation and position of the carrying surface can be adapted to and aligned with another surface with the adjusting means. The carrying surface can hereby be placed in one plane with the second surface, whereby one large support surface is obtained, for instance for an auxiliary transport means in the form of a loading platform, which has a rigid frame and which would not be usable in the case that the different floors were not mutually aligned. Use is preferably made of a loading platform as known from U.S. Pat. No. 4,355,940.

According to a preferred embodiment the adjusting means comprise tilting means for tilting the carrying surface around at least one tilting axis. A tilting axis is an axis along the carrying surface. The orientation of the carrying surface can hereby be adjusted.

According to a preferred embodiment the tilting axis is directed substantially along the longitudinal direction of the carrying surface. A possible tilting of the mobile loading floor can hereby be compensated by tilting the carrying surface. The loading device is preferably provided with bounding means which prevent loads from shifting or falling off the loading device due to the carrying surface tilting out of the horizontal plane.

The tilting means are preferably formed by the support means. A cost-saving is hereby made since the support means, with which the loading device stands on the ground, can also be adjusted to change the orientation. The tilting means preferably comprise a number of legs mutually connected in an x-shape. The carrying surface is supported by a number of, preferably at least three, such legs when the carrying surface is rectangular. The support means are preferably situated at the corner points. The support means are adjustable by means of a cylinder, for instance pneumatic or hydraulic, and the orientation of the carrying surface can hereby be modified.

The adjusting means preferably comprise sliding means for moving the carrying surface in a plane. A properly oriented carrying surface can hereby be displaced in parallel manner, whereby a better connection to a second surface, for instance the mobile loading floor, can be obtained. The sliding is preferably used for fine adjustment of the connection of the carrying surface to the mobile loading floor.

The sliding means preferably comprise two plates which engage movably on each other by means of a dovetail coupling. A sliding connection of two plates, whereby the carrying surface becomes displaceable, is hereby obtained in efficient manner.

In another embodiment the adjusting means are adapted for a height adjustment of the carrying surface relative to the ground surface. Height differences between carrying surface and mobile loading floor can hereby be bridged.

A further preferred embodiment provides a device which modifies the adjusting means during loading of the cargoes in or out of the vehicle. When the loads are transferred, a weight displacement takes place which, as the case arises, results in a height adjustment of the mobile loading floor of the vehicle. During unloading the mobile loading floor will move upward in the vertical direction under the influence of the suspension of the vehicle. This displacement in height direction can be bounded by the adjusting means and the orientation and alignment of the carrying surface with the loading floor can be maintained.

In yet a further embodiment, the adjusting means are adapted to rotate the carrying surface in the plane. A better connection to the second surface, such as the mobile loading floor, can hereby also be obtained.

In a preferred embodiment the adjusting means are adapted to hold the carrying surface substantially horizontal. The load will hereby not shift under the influence of gravity. The alignment with a second surface is preferably postponed until this is necessary, for instance when the loads are transferred.

The adjusting means preferably comprise a cylinder as driving means for the adjustment. Such a cylinder, pneumatic or hydraulic, can be controlled remotely and with the necessary accuracy. The adjusting means are connected to a control device.

According to the invention the loading device is further provided with an auxiliary transport means for loading the mobile loading floor, wherein the auxiliary transport means is movable over the carrying surface. In a preferred embodiment the auxiliary transport means is provided with a number of roller elements and with support means for supporting the load. A loading device is hereby obtained which operates without the need for pallets. Cargoes can be placed on the auxiliary transport means and be displaced therewith over the loading floor and can be placed thereon, but can also be picked up and displaced out of the loading space.

The auxiliary transport means preferably has moving means for moving the auxiliary transport means over a surface, wherein the auxiliary transport means comprises a number of first roller elements arranged at a regular mutual distance for supporting the load which can be placed on the auxiliary transport means, and a number of second roller elements arranged at a regular mutual distance for displacing the auxiliary transport means over the carrying surface, wherein in a first mode the first roller elements are coupled to the moving means and in a second mode the second roller elements are disengaged. An auxiliary transport means is hereby obtained in the form of a double roller device as known from U.S. Pat. No. 4,355,940. Due to the alignment this rigid frame is displaceable over the carrying surface and is supported on the mobile loading floor. The first and second roller elements co-act with each other in the manner shown in the prior art when the auxiliary transport means is moved (away) under the loads. In another mode the auxiliary transport means is displaced using the moving means while the first roller elements supporting the load do not move here because they are disengaged.

It is advantageous according to the invention that in the first mode the first roller elements engage on the second roller elements, and in the second mode the second roller elements are disengaged from the first roller elements. In another embodiment the moving means comprise a number of wheels which are mounted for substantially vertical movement on the auxiliary transport means. Due to this measure a device is obtained wherein the second roller elements are moving means in the first mode and not in the second mode, since they are formed by said wheels. In the second mode said wheels protrude beyond the second roller elements. When the auxiliary transport means is moved, the second roller elements will not rotate, whereby the first roller elements will not rotate.

In a further embodiment the loading device has coupling means for coupling the loading device to the mobile loading floor. At least partial alignment of the loading device with the mobile loading floor can hereby be carried out. The coupling means can after all be used to control the loading floor or to displace the loading device.

In a further preferred embodiment, the loading device is provided with detecting means for detecting the surface of for instance the mobile loading floor and is also provided with a control device coupled to the detecting means and the adjusting means, wherein the control device is adapted to control the adjusting means such that the carrying surface is aligned with the detected surface. Alignment is hereby performed automatically. A suitable detecting means can be a laser. Use is made of the reflection of the laser. In a preferred embodiment, detectable elements such as reflecting parts are arranged on the surface for detecting or on the vehicle in which the surface for detecting is situated. This enables a further accurate alignment.

In an advantageous embodiment, the control device is adapted to continuously compare the surface alignment. This enables modification of the adjusting means when the orientation of the mobile loading floor changes, for instance during transfer.

In yet a further embodiment, the loading device has a positioning part. The positioning part comprises load support means formed by at least a first sub-frame provided with a number of rollers oriented in a first direction, and a second sub-frame provided with a number of rollers oriented in a second direction, wherein the sub-frames are connected movably to the frame of the loading device. A positioning part is hereby obtained on which cargoes placed on the loading device can be displaced in two directions of the loading device so as to thus allow a favourable method of pre-loading to be performed. According to the invention cargoes are loaded onto the loading device before the mobile loading floor in the form of a vehicle is even present. When the vehicle is coupled to the loading device, the pre-loaded cargoes can be positioned on the loading floor in one operation. By means of the positioning part the cargoes are aligned for instance in the width direction. The directions of the rollers of the first and second sub-frame are preferably the length and width direction of the loading device. When loads are supported by the first sub-frame, they can for instance be displaced over the rollers in the length direction, while they can be displaced over the loading device in the width direction when they are supported by the second sub-frame. When supported by both sub-frames, no displacement is possible.

In a further preferred embodiment, the loading device is provided with at least one guide extending substantially parallel to the longitudinal direction. Guiding of a number of elements in the longitudinal direction is hereby possible, for instance loads which are being displaced over the loading device in the longitudinal direction.

In one embodiment the guide is a gear rack. Engagement on the guide is hereby possible using a toothed wheel, whereby displacement along the loading device in the longitudinal direction becomes possible.

According to the invention this is done for instance by load displacing means. These can displace loads over the loading device in longitudinal direction. The loads can thus be pre-positioned on the loading device even before the mobile loading floor onto which they must be loaded is present. The same applies for unloading or offloading of the cargoes from the loading device.

In a further embodiment the load displacing means have a pivoting pusher. The pivot shaft is preferably formed by a shaft parallel to the longitudinal direction. The pushers can hereby be placed behind cargo and can be pivoted aside.

The loading device which makes use of the auxiliary transport means can also use the guide as engagement for drive means, such that the auxiliary transport means is displaceable along this guide. The displacement direction of the auxiliary transport means is hereby aligned with the loading device.

The guide is then preferably connected to the auxiliary transport means, whereby the auxiliary transport means becomes displaceable together with guide.

The invention further relates to an auxiliary transport means for loading and unloading cargo in a vehicle, comprising a frame provided with support means for supporting a cargo placeable on the auxiliary transport means, wherein the support means are formed by a number of first roller elements arranged at a regular mutual distance, and moving means for moving over a surface the auxiliary transport means formed by a number of second roller elements arranged at a regular mutual distance and a number of bearing-mounted wheels connected movably to the frame. With such an auxiliary transport means according to the invention cargo can be loaded into and out of a loading space, for instance a mobile loading floor, without a pallet. The auxiliary transport means is preferably used in combination with a loading device.

The loading device preferably has a first mode wherein the first roller elements are coupled to the moving means, and a second mode wherein the first roller elements are disengaged from the moving means. In the first mode the moving means are formed by the second roller elements and in the second mode the moving means are formed by the bearing-mounted wheels connected movably to the frame. In the first mode a situation is hereby created wherein use can be made of the so-called double-roller device as known from U.S. Pat. No. 4,355,940 and/or Netherlands patent 1 018 793 or 1 014 147. The contents of these patents (patent applications) are included herein by reference. Particularly the content of the operation of the double-roller device is known.

The invention further also relates to a method for transferring a cargo between a mobile loading floor and a loading platform, comprising of loading the cargo onto an auxiliary transport means, moving the loaded auxiliary transport means over the loading floor and over a carrying surface of a loading device in a longitudinal direction of this loading floor, and moving the cargo from or onto the auxiliary transport means onto or from the loading floor, wherein the method is characterized by tilting the loading floor and/or the carrying surface for the purpose of aligning the loading floor with the carrying surface. According to the method use can hereby be made of a loading platform with a double-roller device having a rigid frame, whereby alignment of the supporting surfaces is necessary.

The invention will be further described with reference to the annexed drawings, in which:

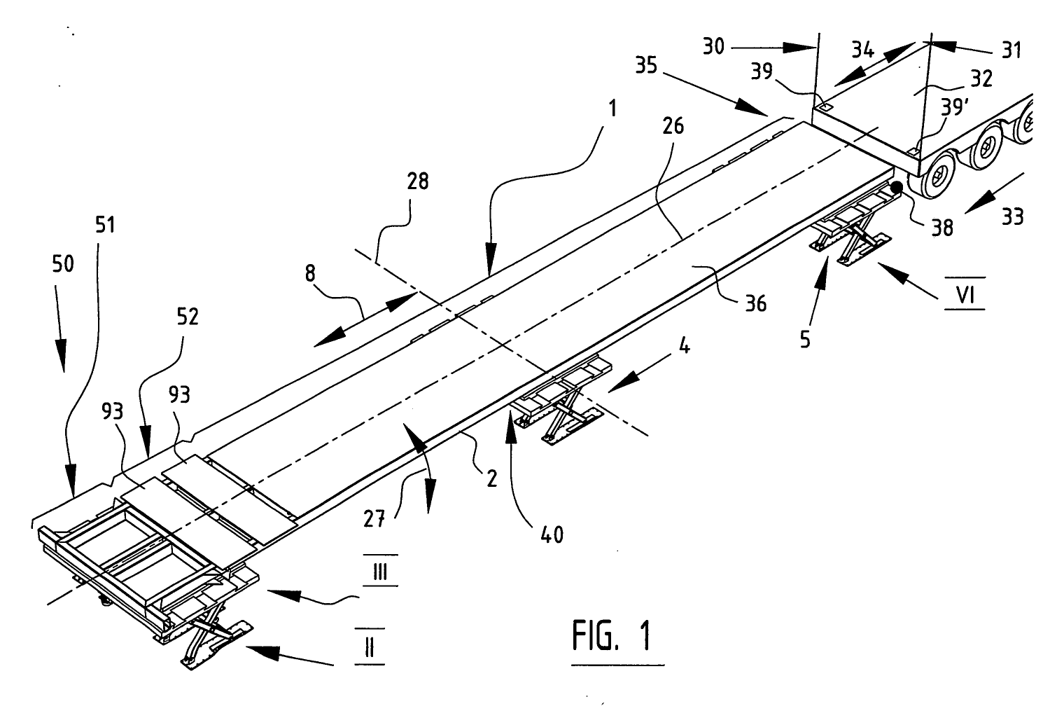

FIG. 1 shows a perspective view of a first embodiment of the loading device,

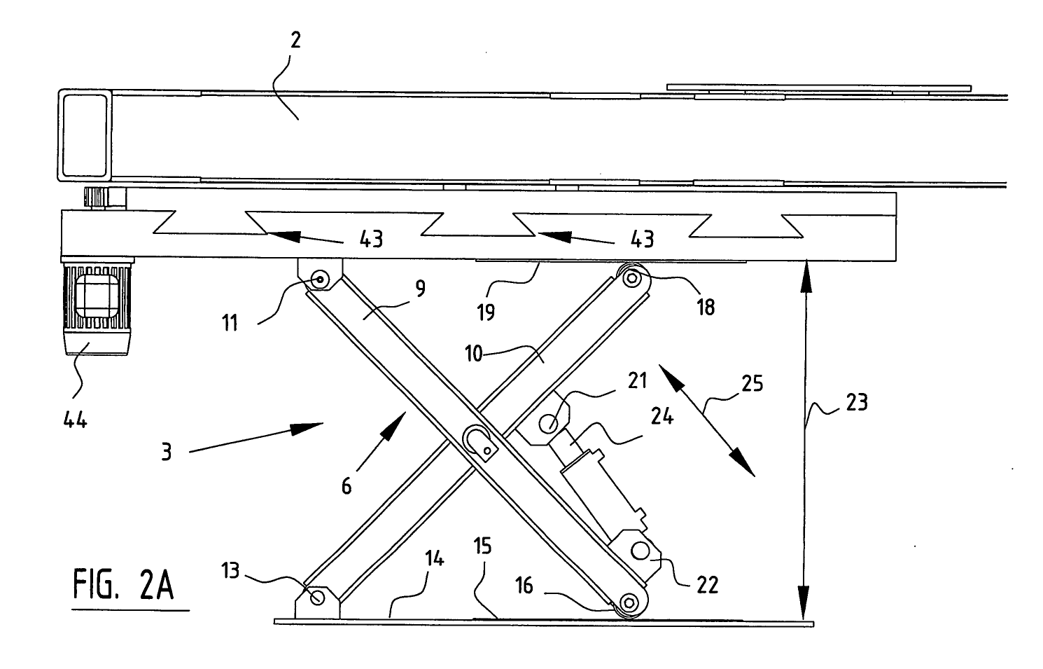

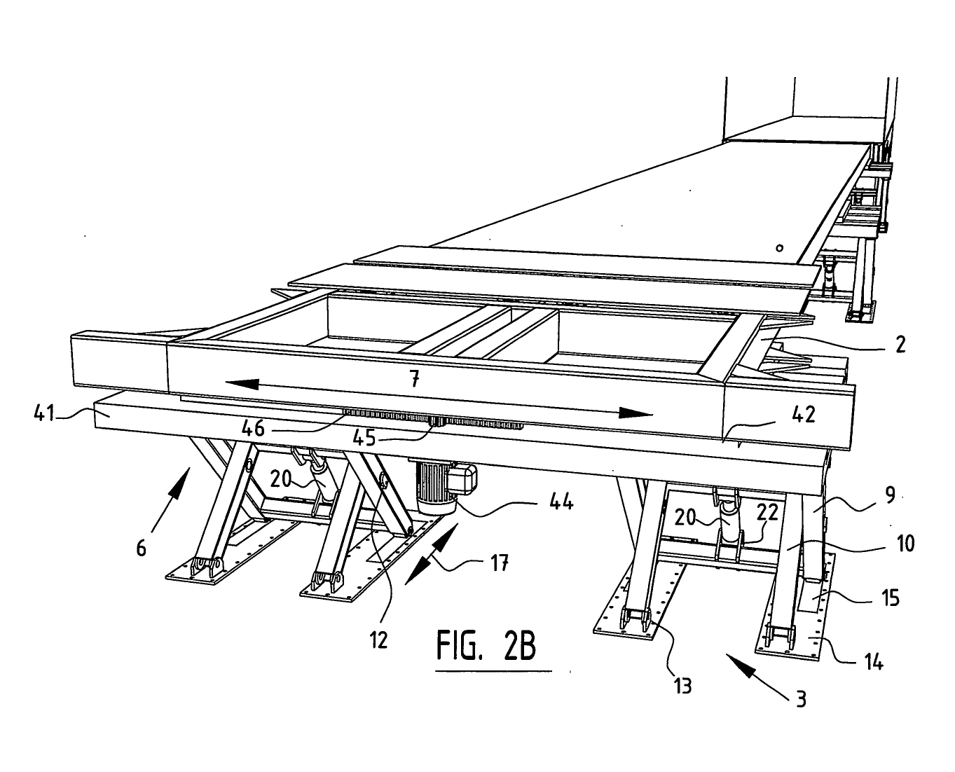

FIG. 2 shows a detail according to arrow II of FIG. 1 of the loading device according to the invention,

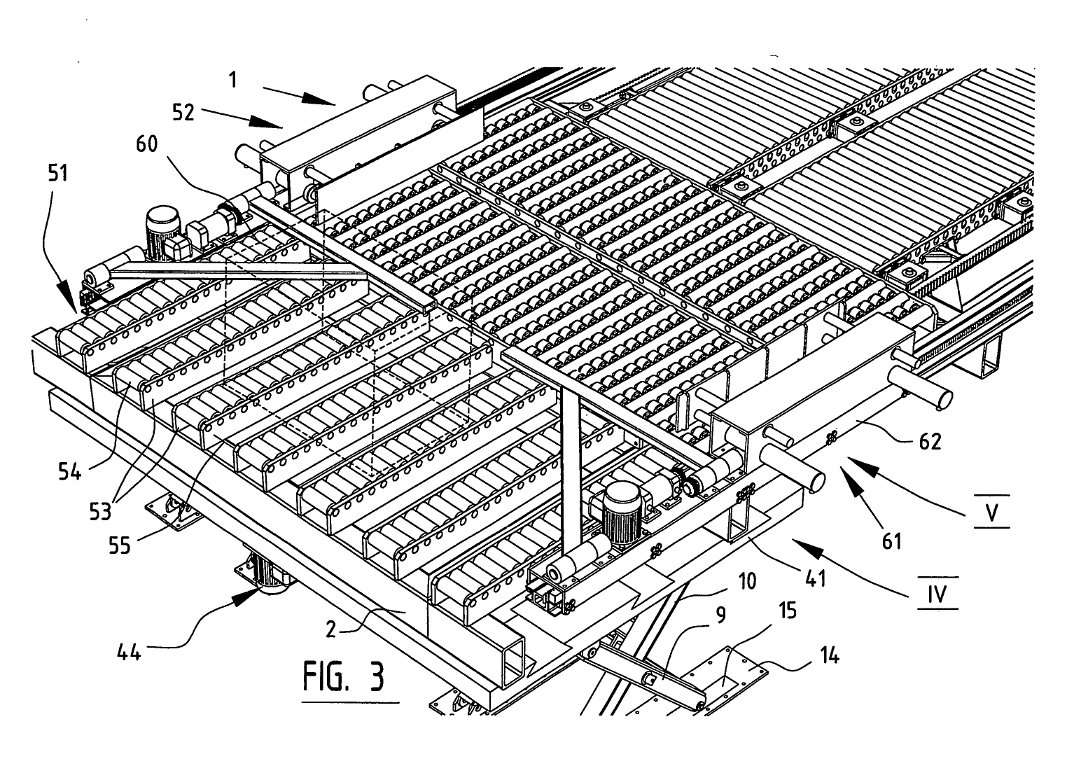

FIG. 3 shows a detail according to arrow III of FIG. 1 of the loading device according to the invention,

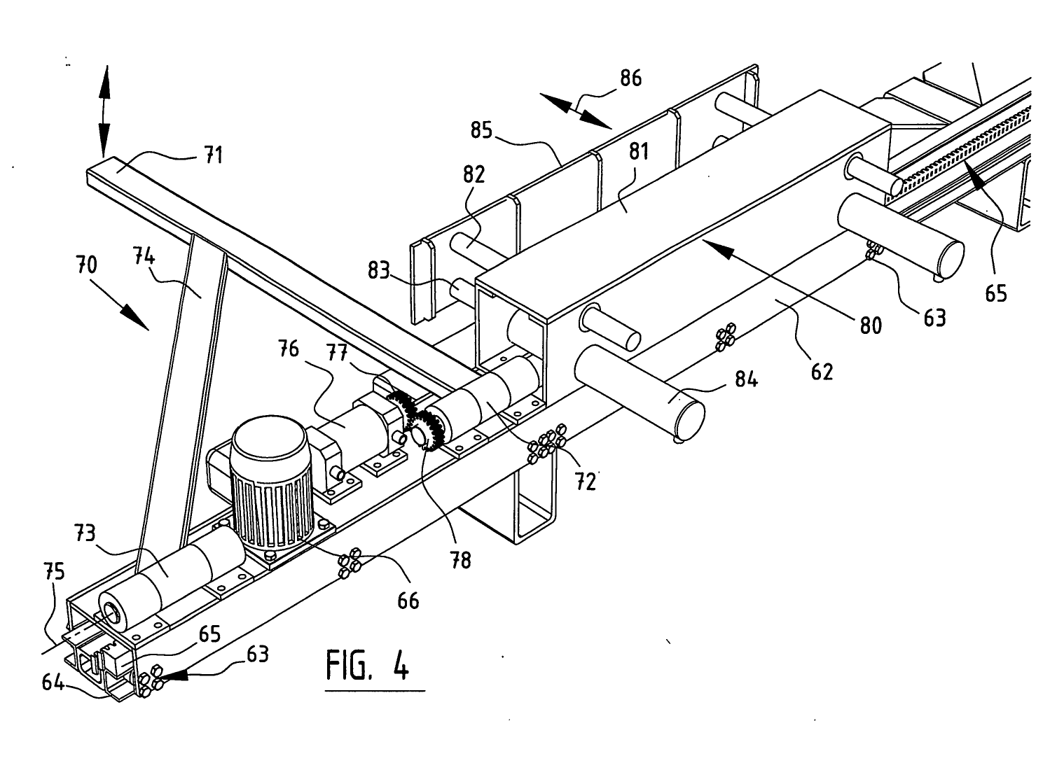

FIG. 4 shows a detail according to arrow IV of FIG. 3 of the loading device according to the invention,

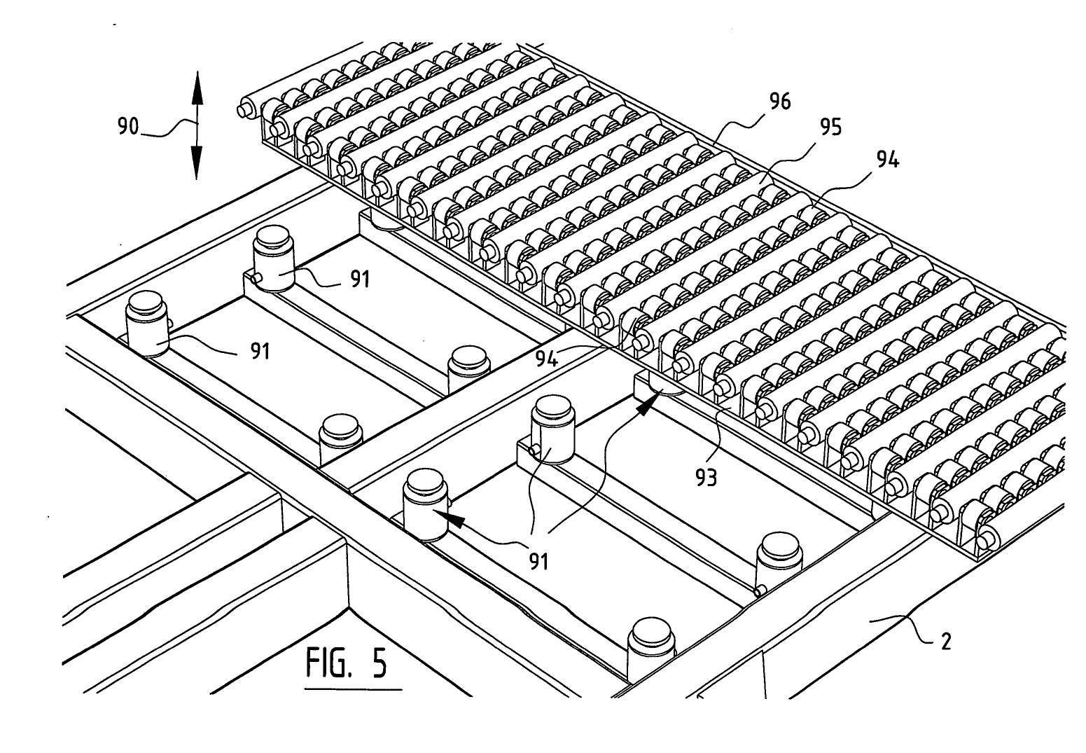

FIG. 5 shows a detail according to arrow V of FIG. 3 of the loading device according to the invention,

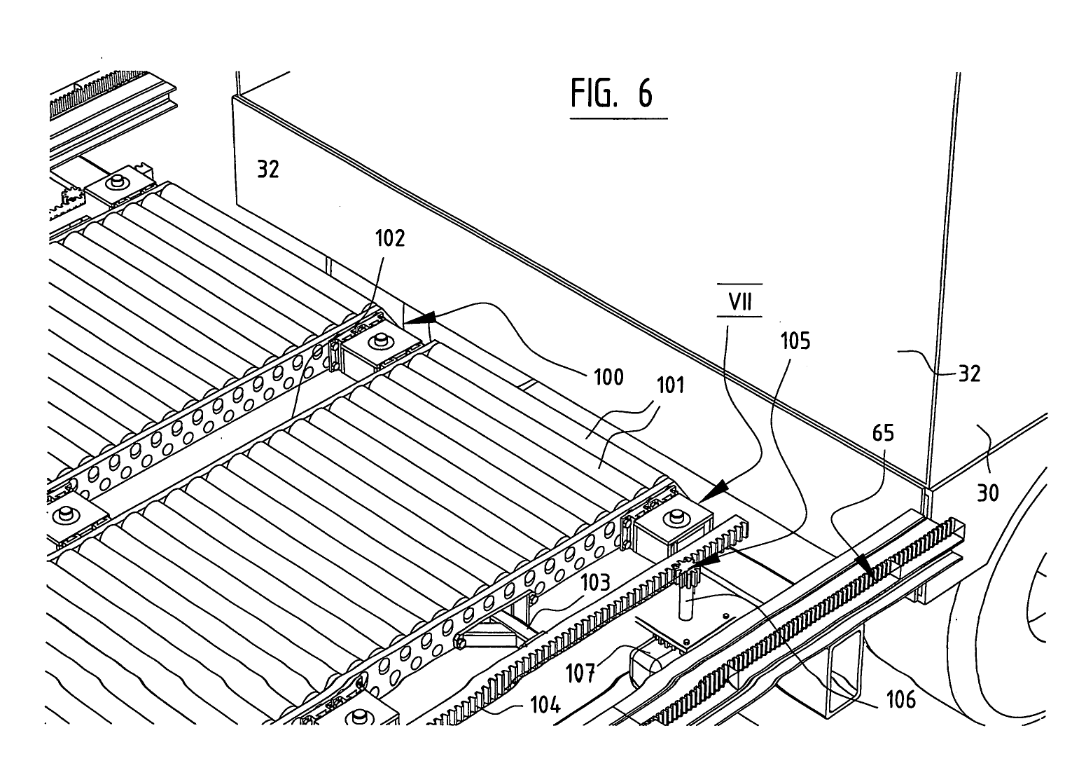

FIG. 6 shows a detail according to arrow VI of FIG. 1 of the loading device according to the invention,

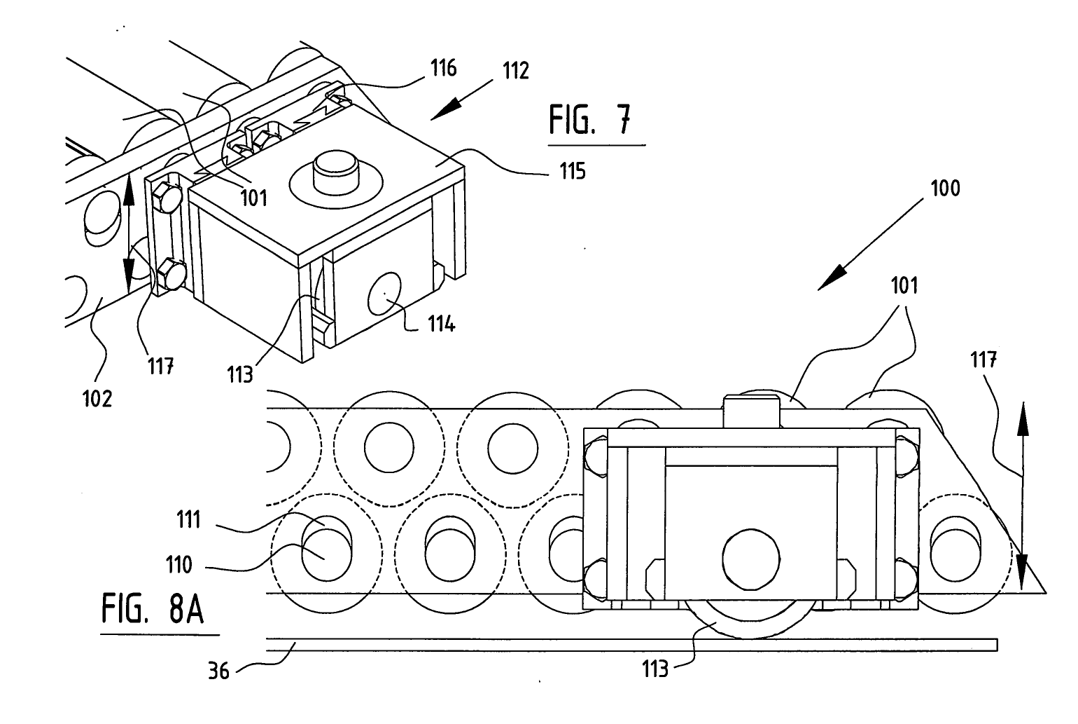

FIG. 7 shows a detail according to arrow VI of FIG. 6 of the loading device according to the invention,

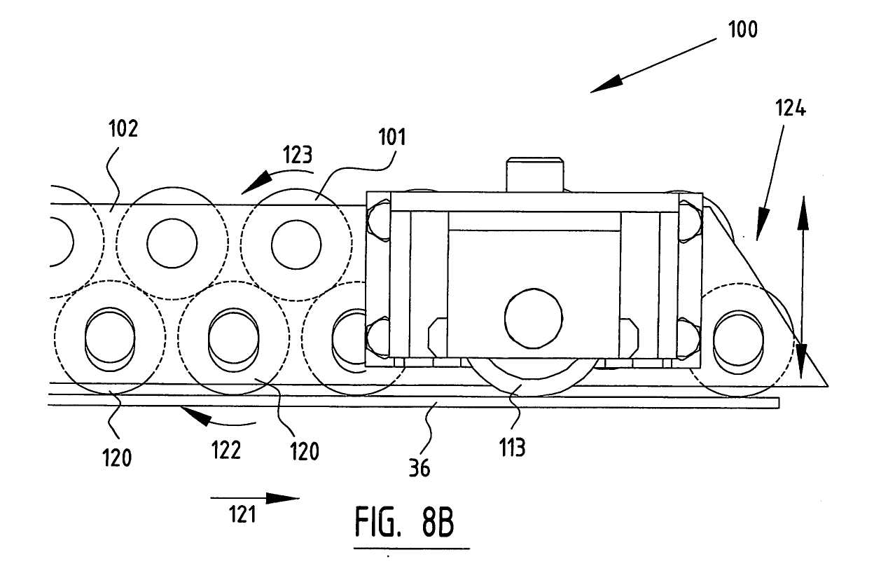

FIGS. 8a-8b show a detail of the auxiliary transport means of the loading device according to the invention in two modes,

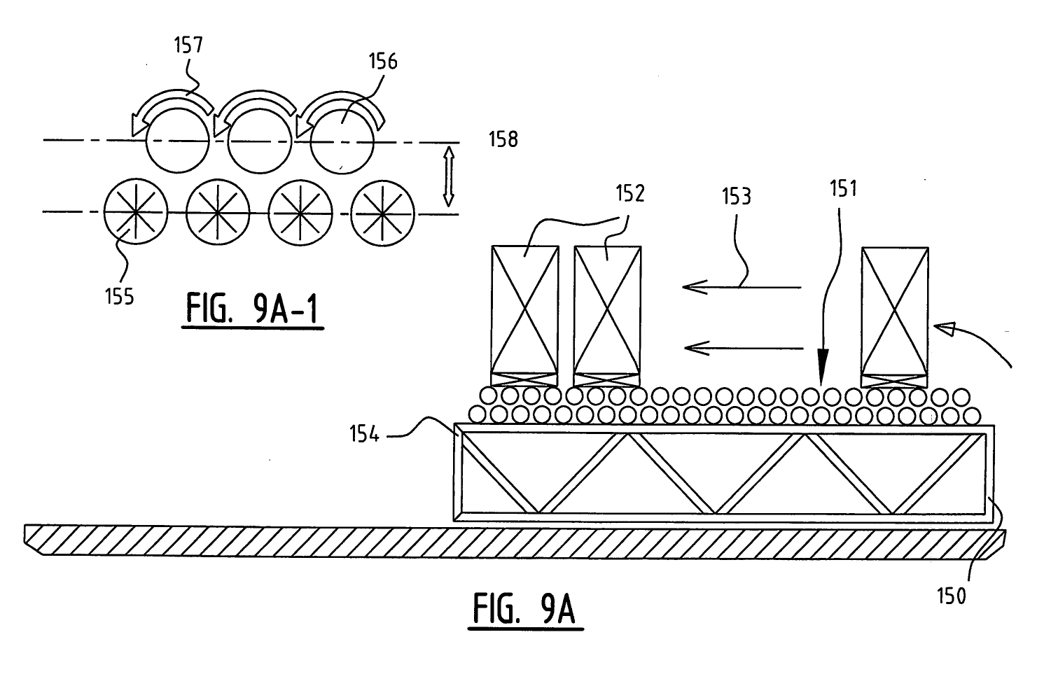

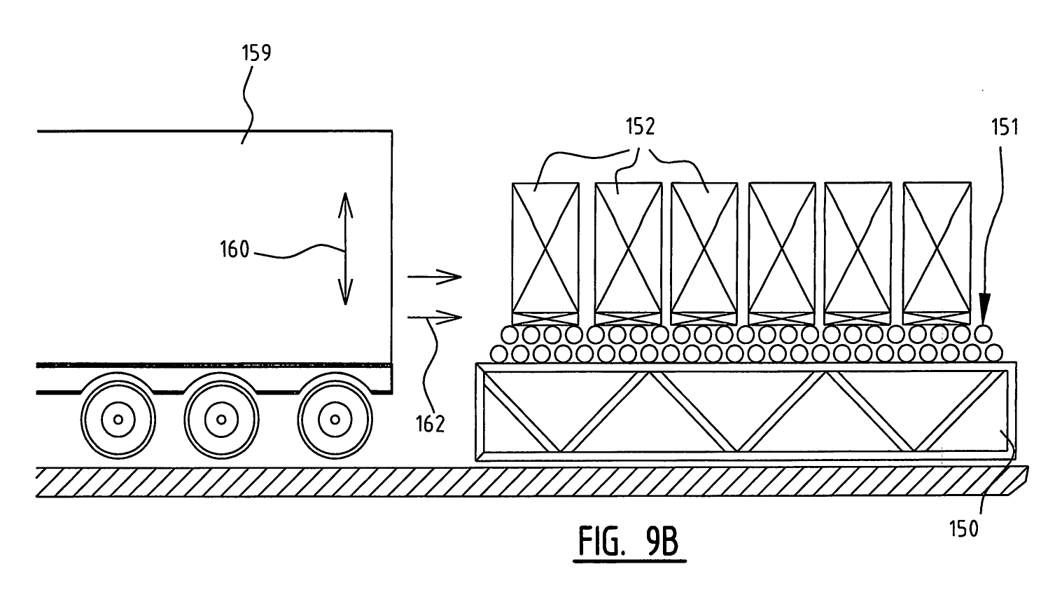

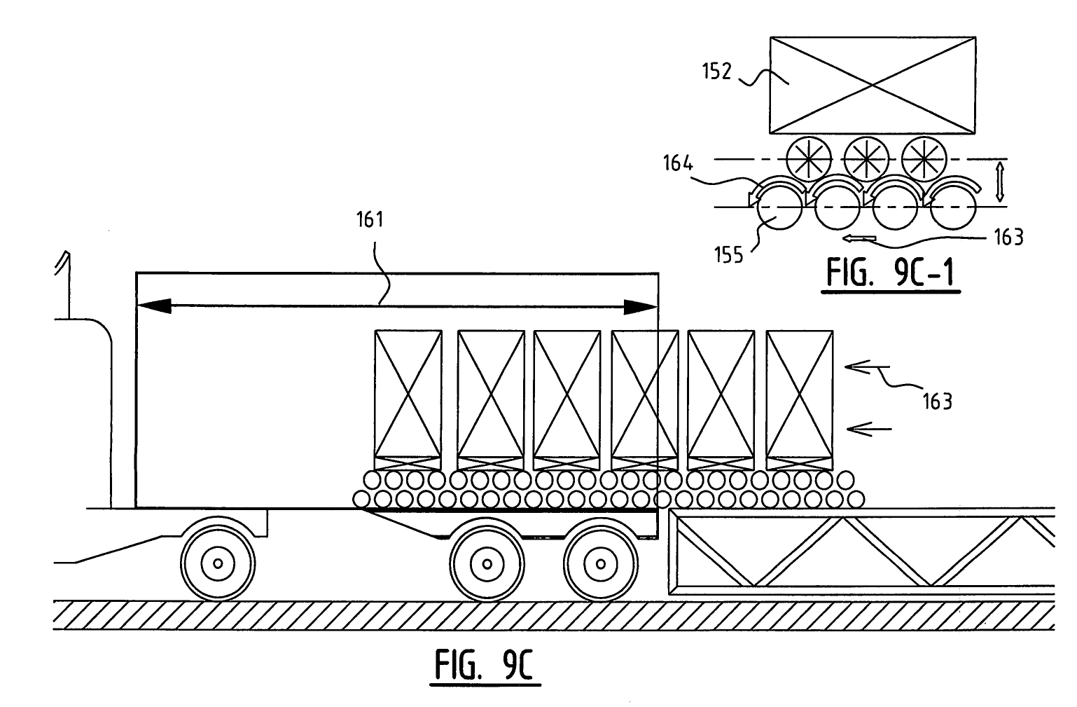

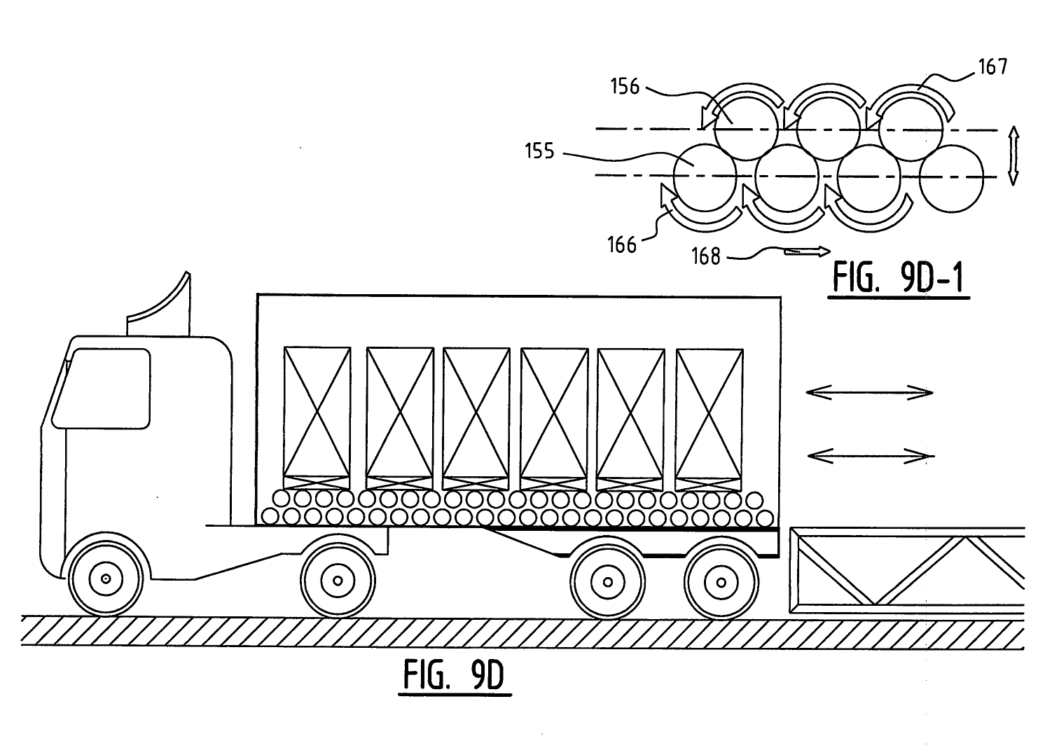

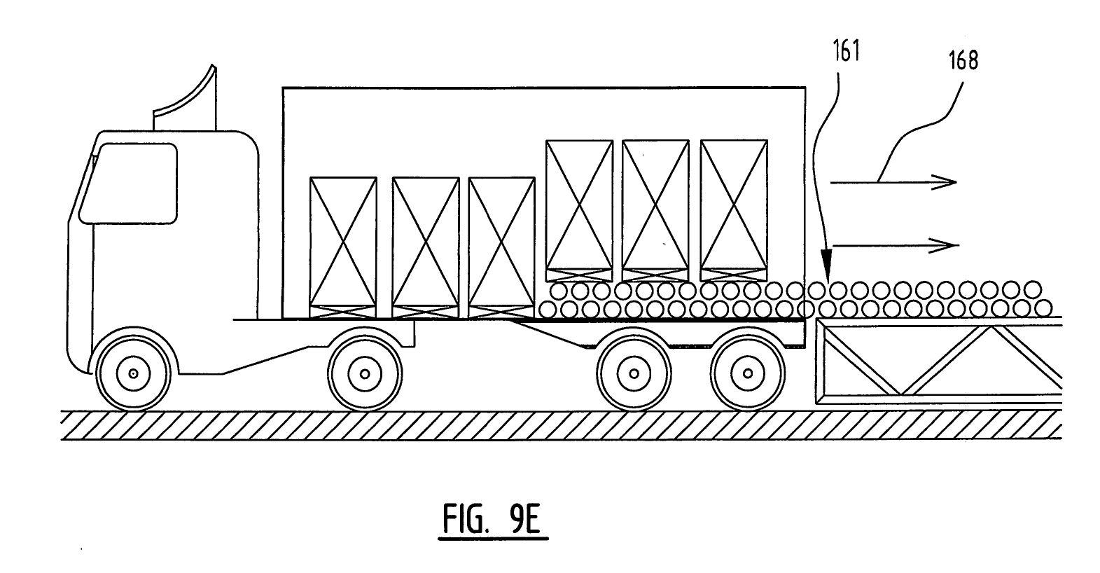

FIGS. 9a-9e show a number of steps of the connection,

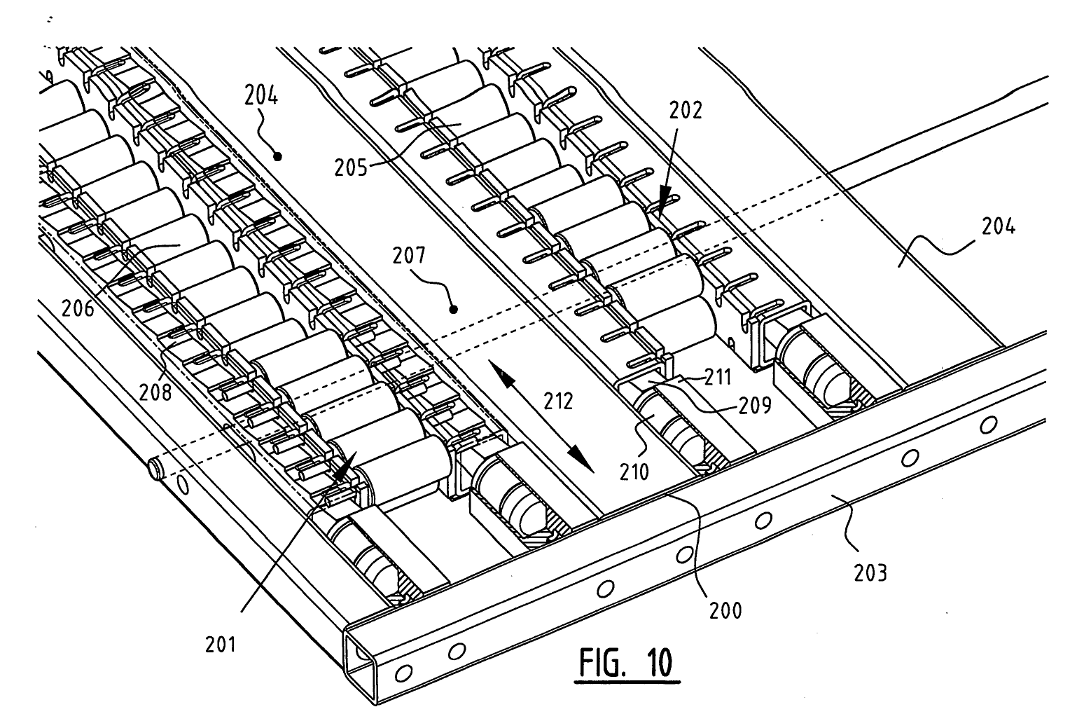

FIG. 10 shows a detail of the auxiliary transport means according to another embodiment,

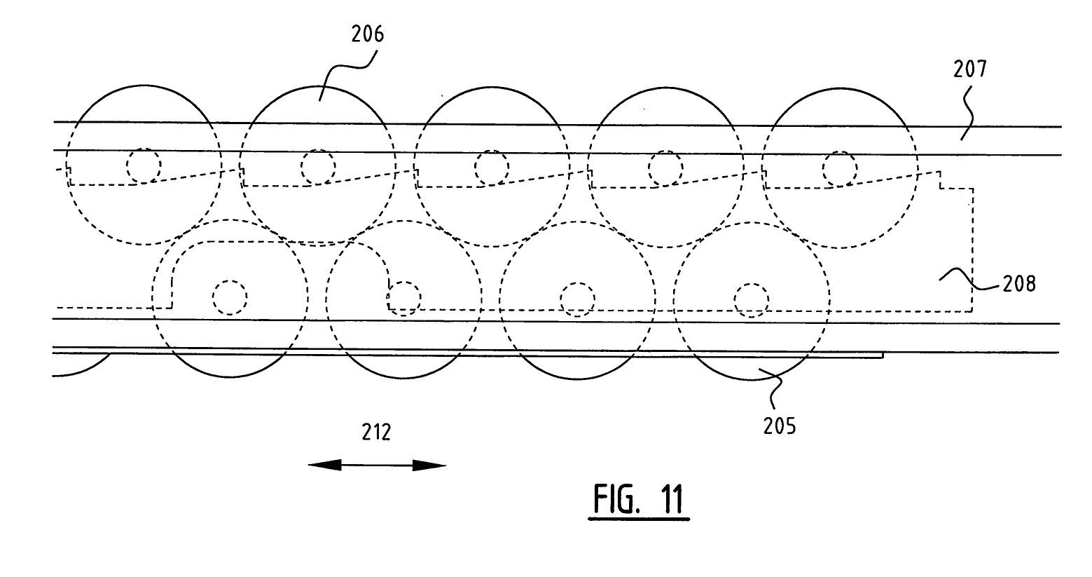

FIG. 11 shows a cross-sectional side view of the rod part.

FIG. 1 is a perspective view of a loading device 1 which is here shown schematically. Loading device 1 comprises a frame 2 which is supported by three support means 3-5 which can be placed on a ground surface. According to the invention the ground surface does not have to be level, but can display unevenness. This is an additional advantage of the invention.

Support means 3-5 are shown in more detail in FIG. 2. FIG. 2 shows the view of support means 3 as according to arrow II. Each support means 3 comprises a number of legs, designated in general with 6, which are situated adjacently of each other in width direction 7. Support means 3-5 are arranged at different positions in longitudinal direction 8. In particular, two support means can be arranged at both longitudinal ends.

Legs 6 of support means 3-5 comprise in each case two arms 9,10 pivotally connected to each other and having a cross shape. Arm 9 is connected at one end to frame 2 via a hinged joint 11. The hinge can pivot and is embodied in known manner. Arm 9 is connected to second arm 10 by means of a second hinge 12. Arm 10 is connected by means of hinge 13 to plate 14 which can be placed on a ground surface. Plate 14 is provided with an additional friction plate 15 over which an outer end of arm 9 can move as according to arrow 17 by means of a bearing-mounted wheel 16. Arm 10 is provided on the free end with a second wheel 18 which is connected in bearing-mounted manner to arm 10 and which supports on a plate 10 which is arranged on frame 2. This end can also move as according to arrow 17.

The legs 6 can vary the height adjustment according to arrow 23 by means of a drive means, in the embodiment of FIG. 2 a cylinder 20 which is pivotally connected 21,22 to both arms 9 and 10. The cylinder provided with piston 24 can be a hydraulic or pneumatic cylinder which is controlled by a control device, which will be described hereinbelow, in order to allow the height adjustment 23 to proceed accurately. The orientation of the loading device is adjusted at the same time. The connections to the control device are not shown in FIG. 2. Extension of cylinder 20 as according to arrow 25 will result in a higher adjustment as according to arrow 23, whereby frame 2 is held at a greater distance relative to the ground surface.

The different legs 6, which according to an embodiment can be 2, 3, 4, 5 and 6 or more in one support means 3, can be provided in each case with an own cylinder. The load-bearing capacity of the loading device is hereby increased. In one embodiment only the outer legs 6 are provided in each case with such a cylinder. Because the respective legs are provided with their own cylinders, the legs can make their own height adjustment. The height adjustment of the leg on the left-hand side (as seen in width direction) and on the right-hand side can be different. A tilting about axis 26, i.e. the longitudinal axis of the loading device, is hereby possible. The tilting is further indicated by arrow 27 in FIG. 1. The adjustment of the respective pistons is coordinated by the control. The control can for instance take place on the basis of “load-sensing”, whereby a favourable distribution of load is obtained.

Since support means 3,4 and 5 are provided in each case with at least a number of cylinders, a tilting of the loading device can be effected about axis 28, an axis in the width direction.

FIG. 1 shows a vehicle 30 formed by a truck provided with a loading space 31 and a loading floor 32. Truck 30 is mobile and can transport cargoes, for instance parcels or small containers or crates and the like, in its loading space 31 and take these to the desired location. Using loading device 1 cargoes of desired form can be arranged on loading floor 32 in loading space 31 or, at their destination, be unloaded out of loading space 31 from mobile loading floor 32.

Vehicle 30 reverses as according to arrow 33 in the direction of loading device 1. The loading space 31 with a longitudinal direction 34 is placed substantially in line with the longitudinal direction 8 of loading device 1. Not shown are optional guide means which are arranged either on the outer end 35 of loading device 1 or close to the outer end of vehicle 30 for guiding or assistance in guiding of vehicle 30 in the direction 33 toward loading device 1. An example of a guide can be a number of arms arranged close to the outer end 35. Guiding can also be implemented in other ways, for instance by means of laser guiding. Additional assist means can optionally be arranged at the outer end of loading space 31, which co-act with the means on loading device 1, whereby the driver of the vehicle receives instructions concerning a desired direction of travel and/or desired corrections.

A vehicle 30 can for instance be provided with a loading flap. According to the invention this can also be used, although it will preferably have to be possible to place the loading flap of the vehicle substantially in one plane with loading floor 32. Loading floor 32 is an example of a mobile loading floor with which the loading device 1 can co-act.

Reversing of vehicle 30 must be carried out roughly as according to arrow 33. The fine adjustment of the coupling between loading device 1 and vehicle 30 is carried out by the options suitable for this purpose of the loading device 1 itself. This will be described below.

Irrespective of the fact of whether mobile loading floor 32 is substantially horizontal or the coupling between vehicle 30 and loading device 1 is accurately aligned, the coupling between vehicle 30 and loading device 1 can be embodied according to the invention by means of adjusting means, formed hereby by support means 3-5 and means to be described further, such that the carrying surface 36 shown schematically in FIG. 1 is aligned with mobile loading floor 32. The orientations of the respective surfaces are aligned and the surfaces are placed mutually in line. In this case mobile loading floor 32, which has a longitudinal direction as according to arrow 34, is placed in line with the longitudinal direction 8 of loading device 1. The mobile loading floor is situated in a plane, which plane is for instance measured by means of measuring means 38 arranged for this purpose on loading device 1.

Measuring means 38 is shown schematically. It comprises for instance a laser. The measuring means is for instance pivotally connected to the frame. The measuring means can hereby be swung aside when cargoes are being moved in or out of loading space 31. Detecting means 39, for instance reflectors and the like, can optionally be arranged close to the outer end of mobile loading floor 32 which is coupled to the loading device. Detection is hereby possible in more simple manner.

In order to place the surfaces 36 and 32 in one plane, tilting along axes 26,28 of the loading device is possible by means of adjusting means 3-5.

Loading device 1 is provided with further adjusting means such as plates 41,42, which are mutually coupled by means of a dovetail coupling 43. The plates are mutually engaging by means of this coupling, but they can be displaced relative to each other. In the embodiment of FIG. 1 the support means 3-5 are connected in each case to frame 2 by means of the sliding means 40 formed by the two plates 41,42. Displacement of the loading device in the width direction according to arrow 7 is hereby possible. The longitudinal directions 8 and 34 of carrying surfaces 36 and mobile loading floor 32 can hereby be aligned.

The sliding means in support means 3 and 5 can be moved independently of each other, whereby a rotation can be executed by carrying surface 36 in the plane around the centre formed by the intersection of axes 26 and 28. The coupling of support means 3,4 and 5 to sliding means 40 can optionally take a bearing-mounted form, whereby the rotation is simplified. Using the sliding means the carrying surface 36 can be moved in each case in the orientation plane.

Sliding means 40 are provided with a drive 44. In the embodiment of FIG. 1 three drives 44 can be arranged for the three sliding means 40 in each case. Drive 44 is provided with a shaft on which a toothed wheel 45 is arranged non-rotatably which can engage on a gear rack 46 fixedly connected to plate 42. Displacement of plate 42 relative to plate 41 is hereby possible. Drive 44 is fixedly connected to plate 41. The shaft of drive 44 runs through plate 41. Drive 44 can be actuated by means of the control device, to which it is coupled via a suitable connection, for instance an electrical connection, in accordance with the detection of detecting means 38, optionally in co-action with reflectors 39, the findings of which are likewise transmitted to the control device. The control device processes the detected orientation plane and translates this into movements of the respective adjusting means. Suitable software carries out the processing of the input value and calculates the output in the form of adjustments of the diverse adjusting means.

When cargoes are carried from loading device 1 onto mobile loading floor 32 or vice versa, a change in the orientation of the planes can take place. If this change is detected, when it is for instance recorded with gyroscopes and the like or other suitable detecting means, the adjusting means can be controlled by the control device to follow the change. During the transfer of loads the adjusting means, such as sliding means 40 or support means 3-5, can be automatically controlled.

Before or after the coupling to vehicle 30 is made or broken, carrying surface 36 of loading device 1 is placed substantially in a horizontal plane. This is irrespective of the ground surface. This has the advantage that cargoes which have been or are being placed on loading device 1 do not undergo any lateral forces because of gravity.

Two zones can be designated close to the outer end 50 of loading device 1, i.e. supply zone 51 and positioning zone 52. This is shown in more detail in FIG. 3.

A load 60 is shown with dotted lines in FIG. 3. Load 60 is placed on supply zone 51 by for instance a fork-lift truck. Supply zone 51 comprises a number of roller tracks connected to frame 2 and formed by successive wheels bearing-mounted in a row. Arranged between two upright walls 53 connected to the frame is a series of wheels 54 over which a load 60 is displaceable in longitudinal direction 8. Owing to the gap 55 between the assemblies of upright walls and wheels it is possible to place loads on this area and remove them by means of fork-lift trucks, wherein the fork can be placed in the open space 55 between the assembly. A fork-lift truck is provided with an adjustment with which the distance between the forks can be modified. This distance will have to be adjusted here to the distance between open spaces 55.

A load which is placed on wheels 54 can be moved in the longitudinal direction and can be transported to positioning zone 52.

Loading device 1 is provided on either side in the width direction 7 with two pushing and positioning means 61 displaceable along the longitudinal direction 8 and arranged on a guide. These are shown in more detail in FIG. 4.

The pushing means and positioning means 61 are mounted on a frame 62, which frame is provided with a number of wheels 63 which engage on and are movable over a guide 64. Guide 64 is connected fixedly to frame 2 of loading device 1. Also arranged close to the guide is a gear rack 65 which extends substantially over the full length of loading device 1. A toothed wheel (not shown) which is connected to a shaft (not shown) of a drive 66 engages on the gear rack, and with the drive the whole sub-frame 62, on which the pushing and positioning means are arranged, can be displaced in longitudinal direction 8 of the loading device. Such devices are arranged on either side and they can be driven simultaneously.

A pushing means 70 is firstly arranged on sub-frame 62. This pushing means comprises a pusher rod 71 connected to sub-frame 62 by means of two hinges 72, 73. The hinges are arranged on the ends of arms 71, 74 of pusher 71. Pusher rod 71 can hereby pivot about axis 75 as according to arrow 76. The pusher can hereby take up a number of positions, wherein the most important are a horizontal position as shown in FIGS. 3 and 4, and a vertical position (not shown). In the vertical position the pusher can move along the load 60. The pusher rod is then placed behind load 60 and can push it in the direction of vehicle 30.

Drive 76 carries out the pushing. Drive 76 is connected by means of a shaft to a toothed wheel 77, which engages on a toothed wheel 78 which is connected to arm 71. The movement of pusher 71 can hereby be controlled by means of drive 76. Both drives 66, 76 are connected to the control device, whereby they can be controlled from a central point.

A positioning means 80 is also arranged on sub-frame 62. The positioning means comprises a fixed part 81 on which are arranged a number of guides for arms 82, 83, at least one of which is connected to the piston of cylinder 84. The arms are connected at one end to plate 85, which is movable according to arrow 86 and with which loads can be positioned in the width direction on the loading device, and in particular on the positioning part. It is here also the case that positioning means 80 are movable along the longitudinal direction 8 of loading device 1 via sub-frame 62.

Positioning part 52 has been made suitable for moving loads 60 in the longitudinal direction and width direction. For this purpose two sub-frames are provided at the location of positioning part 52. The sub-frames comprise a roller plane. At least one of the roller planes can be moved vertically as according to arrow 90 in FIG. 5 by means of jacks 91, whereby the roller planes become movable relative to each other.

The roller plane, such as roller plane 93 shown in FIG. 5, is a plate provided with a number of upright parts to which wheels 94 are movably connected, for instance bearing-mounted. Wheels 94 are suitable for displacing the load in the longitudinal direction of the loading device. When these wheels protrude above the longer wheels 95 in the shown embodiment which are connected to a second roller plane 96, the load will be displaceable in the longitudinal direction, while when wheels 95 protrude above wheels 94, the load is displaceable in width direction 7. The control device can be coupled to jacks 91 in order to be able to move at least one of roller planes 93, 96 as according to arrow 90. The control is synchronized with the operation of positioning means 80. When these are in operation, the long rollers 95 will protrude above the smaller wheels 94.

Other embodiments of the wheels are of course possible. Other means can also be applied to enable displacement of loads on support means in the longitudinal and width direction. An advantage of wheels is that very many types of load, also loads with a more or less porous structure, can be supported. This in contrast to a support means, such as an air bed, very suitable for a number of types of load.

As already indicated, FIG. 1 shows a partly cut-away structure of the loading device, wherein roller planes 93 are visible in positioning zone 52 without the wheels 54. The same applies for supply zone 51.

FIG. 6 shows the view of outer end 35 of loading device 1 as according to arrow VI.

Placed on carrying surface 36 is an auxiliary transport means 100, which is shown in more detail in FIG. 6. Auxiliary transport means 100 is for instance a loading platform which is at least provided with a first set of wheels, preferably formed by rollers arranged at regular mutual distance, the shafts of which are mounted in a width direction 7. Rollers 101 are a component of the first set of roller elements. A load 60 can be placed on rollers 101. In a first mode of the auxiliary transport means, loads can be displaced over rollers 101 without the auxiliary transport means 100 moving therein.

Auxiliary transport means 100 comprises a frame 102 which extends substantially in a longitudinal direction. A large number of roller elements is arranged substantially in the width direction.

Using pusher 71 a load is movable over the upper roller elements 101. In this embodiment a gear rack 104 is connected to frame 102 via a connecting means 103, on which rack there engages a toothed wheel 105 connected to shaft 106, which is connected to a motor 107. Auxiliary transport means 100 is displaceable in longitudinal direction 8 by means of this drive. It can extend beyond the outer end 35 into loading space 32. Loads which are placed on auxiliary transport means 100 are thus carried into loading space 31.

FIG. 7 shows a detail according to arrow VII of frame 102 and rollers 101. Rollers 101 are provided on an end with a shaft 110 which protrudes into a receiving space 111 arranged in the for instance steel frame 102. Some vertical movement of rollers 101 relative to the frame is hereby possible.

Further connected to frame 102 is a housing-like part 112 in which is accommodated a wheel 113 which is rotatably connected to housing part 115 via a shaft 114. The housing-like part 112 is connected to frame 102 for vertical movement according to arrow 117 by means of a dovetail coupling 116. Wheel 113 can move at least vertically as according to arrow 117 relative to the fixed frame 102. It is hereby possible, as shown in FIG. 8A, to give the auxiliary transport means 100 a first position wherein, when a load is arranged on supporting wheels 101, these first roller elements 101 can move freely relative to the moving means, which in this first position are formed by the wheel 113 which supports on surface 36, the carrying surface of the loading device.

In housing part 112 there is accommodated a drive (not shown), such as a motor or a cylinder, which can perform the vertical movement as according to arrow 117. The drive is preferably connected to the control device, whereby the movement according to arrow 117 can be regulated.

FIG. 8B shows the second mode wherein it can be seen that the second roller elements 120, which protrude on the underside of frame 102, support on carrying surface 36 and thus become the moving means of auxiliary transport means 100. Wheel 113 is still just in contact with carrying surface 36 or is clear thereof.

When auxiliary transport means 100 is moved in the direction according to arrow 121, each roller element 120 will rotate according to arrow 122. The rotation takes place around each shaft. The second roller elements 120 in each case have the same size as first roller elements 101. The second roller elements 120 engage on roller elements 101. Contact is ensured by the possible vertical movement of first roller elements 101, whereby this latter falls in each case between the two mutually adjacent roller elements. The rotation according to arrow 112 is therefore transmitted to the first roller elements 101, which will begin to rotate as according to arrow 123.

The operation of such a double-roller device is for instance known from the U.S. Pat. No. 4,355,490 and the Netherlands patent 1 041 147 or 1 018 793 of Meijer. The operation as described in one of these documents is applied here.

A load which is placed on the upper series of roller elements 101 will not move relative to carrying surface 36 in the position according to FIG. 8B. The load is in fact held still relative to carrying surface 36 by the transmission of the rotation according to arrow 122 of moving means 120 onto the first roller elements 101 which support the load. It hereby becomes possible when loading the mobile loading floor 32 to move the auxiliary transport means 100 out from under the loads arranged in loading space 31, wherein these loads move, or to some extent topple, off the auxiliary transport means at the front. In the preferred embodiment the front end 124 of auxiliary transport means 100 can be embodied such that it slopes, whereby a smaller height difference occurs between the upper roller elements and the lower roller elements. The situation of FIG. 8B also makes it possible to lift loads arranged on the mobile loading floor onto the auxiliary transport means 100 by positioning the auxiliary transport means 100 between the loads and the loading floor, wherein the auxiliary transport means slides therebetween. In addition, the load will be carried and supported by the first roller elements, and due to the engagement between the first roller elements and the second roller elements the load will not move relative to the mobile loading floor 32.

FIG. 9 shows schematically the loading and unloading of cargoes 152 in a vehicle by means of loading device 150 provided with an auxiliary transport means 151 in another embodiment.

FIG. 9A shows the loading of the platform with loads 152. Loads 152 can optionally be arranged on a pallet or be arranged on the support means without pallet. Loads 152 are placed on the auxiliary transport means via the supply part and the positioning part, situated in the embodiment according to FIG. 9 on the right-hand side of the drawing.

The loads are transported over the auxiliary transport means as according to arrow 153, for instance by the carriers or pushers according to the first embodiment. The carriers or pushers are not shown, but can move along loading device 150 in the longitudinal direction as according to arrow 153.

The auxiliary transport means 151 takes the form of a loading platform which is provided with two series of roller elements which are connected to the loading platform in bearing-mounted manner.

The double-roller device according to this embodiment comprises first roller elements 156 and second roller elements 155. The second roller elements 155 form the moving means of loading platform 151, because these rollers run over carrying surface 154 of loading platform 150. The roller elements are shown in a second mode in FIG. 9A, and in more detail in FIG. 9A-1, wherein the first roller elements 156 are situated a distance above the second roller elements 155. The first roller elements form the support means for load 152 which, when this load is moved according to arrow 153, has the result that the first roller elements 156 will rotate as according to arrow 157. Because the first roller elements are disengaged from the second roller elements, i.e. disengaged from the moving means, support means 156 can rotate without the frame moving herein. The loading platform is provided with means for holding the first roller elements 156 at a distance from the second roller elements 155, wherein a displacement according to arrow 158 has taken place. This can be designed in appropriate manner by the skilled person.

FIG. 9B shows a second step of the method according to the invention. Buffered loads 152 stand ready on loading platform 151. The amount of cargo depends on the truck 159 that is to be loaded. Truck 159 has a loading space in which the loads can be placed. The height 160 of the loading space is important. The height 160 may not be less than the height of the loads together with loading platform 151.

The depth of loading space 161 is the maximum length of the waiting loads 152 on the auxiliary transport means 151. This is the maximum quantity of cargo which can be placed in the loading space.

Not visible in FIG. 9 is that the width of the loads and the width of the auxiliary transport means is at most equal to the width of the loading space.

Vehicle 159 drives up as according to arrow 162 with open loading space in the direction of loading device 150.

FIG. 9C shows the next step, wherein the auxiliary transport means 151 is moved as according to arrow 163 while loads 152 are supported. The loaded auxiliary transport means 151 is rolled into the loading space.

The moving means formed by the second roller elements 155 move as according to arrow 164, whereby the loading platform will move according to arrow 163.

In a favourable embodiment, loading platform 151 is provided with blocking means. In FIG. 9A-1 the moving means are formed by the second roller elements, shown as locked with the cross. In FIGS. 9C and 9C-1 the supporting means that support a load 152 are blocked, whereby the cargo will not move relative to the loading platform. Suitable blocking means can be chosen by the skilled person. The blocking means can be controlled by the control device (not shown).

Before loading platform 151 is rolled into the loading space or after loading has commenced, loading device 150 is aligned with the loading space such that carrying surface 154 is aligned with the loading space of vehicle 159. By already allowing the auxiliary transport means 151 to protrude slightly into the loading space, the free end of the loading platform situated in the loading space can be used as an aid for detecting the orientation of the loading space. The control device can for instance be connected to sensors on the front side of the loading platform.

FIG. 9D shows the situation wherein the loading platform has been moved wholly into the loading space. In this embodiment the moving means of loading platform 151 are driven by a motor arranged on loading platform 151. The loading platform can thus move separately of loading device 1. This in contrast to the previously shown embodiment.

Loading platform 151 continues to travel in the loading space until it rolls against the end of the loading space, as shown in FIG. 9D. At this moment the loads can be removed from the loading platform.

The change in the second situation shown in FIGS. 9A-1 and 9C-1 is necessary here. The transition is carried out by moving rollers 155, 156 toward each other by reducing the distance between these rollers, indicated with arrow 158. A suitable moving means/driving means can be used for this purpose. The first situation of loading platform 151 is shown in FIG. 9D-1.

When the second roller elements 155 move over the mobile loading floor of vehicle 159, these roller elements will move as according to arrow 166 because the rollers now engage on each other. Owing to the engagement on the first roller elements 156 they will rotate under the influence of friction as according to arrow 167. The result hereof is that the loads supported by the first roller elements 156 will remain stationary relative to the floor. The loading platform is now moved out of the loading space as according to arrow 168, as shown in FIG. 9E. The loads roll off loading platform 151 and remain behind in the loading space. A loaded loading space is hereby obtained.

During loading of vehicle 159 weight will be displaced from the loading device 150 into the vehicle. The suspension of the vehicle will hereby result in the mobile loading floor changing in orientation. This can be measured and result immediately in a modification of the adjusting means of loading device 1.

The method for unloading cargoes from a truck is the same as that shown in FIG. 9, only the steps are then carried out in reverse sequence. The auxiliary transport means is pushed under the cargo.

In the first situation the loading platform 151 can be pushed under the cargo standing ready in a loading space.

It will be apparent to the skilled person that the invention can be embodied in different ways, but other embodiments wherein use is made of the same inventive concept will however fall within the scope of the appended claims.

A number of variants are mentioned here and form part of the present invention.

The supporting device is rotatable and translatable around x-, y- and z-axis respectively direction. The support means co-act in order to perform these rotating and translating movements. The said movements can be the result of individual moving means for each movement or a combination of two moving means. A rotation around the longitudinal axis of the loading device is brought about by raising or lowering the support means on one of the sides of the loading device. An adjustment in the z-axis direction can take place with the support means, or additionally by a movable connecting means between support means and load platform. This can for instance be a telescopic and/or hydraulic connecting means.

The frame preferably comprises a number of bearing parts in the longitudinal direction, preferably a number of profile parts. The frame preferably also comprises a number of bearing parts in the width direction.

In one embodiment the pre-loading unit can be aligned with the carrying surface for loading, of for instance a vehicle. Once placed on the loading device, the cargo can hereby be further processed by the loading device without the cargo having to be tilted herein.

The nose of the auxiliary transport means which is movable in the vehicle is preferably embodied as a slide, i.e. as a sloping part which can slide over a supporting floor and under a load in more efficient manner. Rollers, preferably a double-roller device, can be accommodated in this nose part. These rollers have a smaller size than the rollers of the rest, i.e. the largest part, of the auxiliary transport means. Since it is generally not the intention that a load be positioned on this nose part, this double-roller device does not have to have the two modes according to the invention, although in another embodiment the nose does have them. The nose part can be releasably connected to the auxiliary transport means.

Since the loading space of a vehicle differs greatly from vehicle to vehicle, it is possible to embody the auxiliary transport means such that the width thereof can be adjusted. The mutually adjacent double-roller tracks can be displaceably, preferably slidably connected to a frame part of the auxiliary transport means by means of hydraulic cylinders. The mutual distance and thus the width of the auxiliary transport means can thus be adjusted by the cylinders.

According to yet another further embodiment, the auxiliary transport means can be provided with two lying wheels. These wheels are integrated on the front side of the unloading unit. Use is made of these lying wheels to enable correction of the whole in a determined direction. Because the internal widths of the loading floor of trucks differ somewhat from each other, the centre distance of the two wheels is adjustable. Should the unloading unit deviate from the centre line, one of the wheels will run against the side of the truck and manoeuvre itself into the correct position again. When a loading space is not provided with such a side wall, the system can nevertheless be applied. This is because there will always be uprights present in the loading space, against which the wheel can react during possible deviations from the centre line. It is assumed that deviation will be minimal, whereby minimal steering corrections will be necessary.

The rollers preferably have a diameter of 28 mm and a width of 60 mm. In a preferred embodiment the rollers rotate around the shafts of around 6 mm in size. The rollers are enclosed between the tubular profiles. The whole is held together by means of spacing bushes and pull rods. In one embodiment a choice has been made to construct the roller track from compartments of 1 m. Fourteen elements are thus required to load a trailer with a loading space 13.7 metres deep. The advantages of constructing from elements are:

the rigidity in the horizontal plane can be varied

complete compartments can be mounted on each other on site

it is possible to replace a compartment, repairs can hereby be carried out quickly.

FIG. 10 shows a detail of an auxiliary transport means according to another embodiment. Shown is the auxiliary transport means 200 which is provided with a number of double-roller tracks, two of which 201,202 can be seen here. The auxiliary transport means has a frame part in the form of a frame or border 203. A number of profiles 204 extending parallel to tracks 201,202 are arranged between the borders. These profiles are connected to border 203. A number of the upper rollers 206 are omitted in each case for the sake of clarity.

Tracks 201,202 comprise series of rollers 205, 206 lying one above the other. The rollers are rotatable relative to frame tube 207. Each roller is suspended between two frame tubes 207, wherein the shaft of a roller is received in a recess in frame tube 207. For upper rollers 206 the recess is open toward the top and the shaft of roller 206 can thus be displaced in vertical direction. Rollers 206 lie loosely on lower rollers 205 and are held so by gravity.

A rod part 208 is received displaceably in the hollow frame tube 208. The shafts of upper rollers 206 are supported by the upper surface of this rod part 208. The rod part is shown in cross-section in a side view in FIG. 11. The outer end 209 of rod part 208 is connected to a piston 210 of a cylinder 211. Through operation of the cylinder, controlled by a suitable control device, the shafts of upper rollers 206 will be supported in each case by another part of the displaced rod part which can be moved as according to arrow 212. Since the height of the rod part, as shown in the cross-section, is different in each case, rollers 206 will hereby be vertically movable. From a first mode, wherein upper rollers 206 support on lower rollers 205, roller tracks 201 and 202 can thus be brought into a second mode wherein the rollers are not mutually engaging. In the first mode rotation of a lower roller will result in rotation of the upper roller, resulting in the described operation of the double-roller device.

Separation of the two layers of rollers, the lower and the upper, is realized by means of the profiled upper surface of the rod part, which upper surface has a saw-like toothing, indicated in FIG. 11 with dotted lines.

The device according to FIG. 10 can be applied without a separate roller element being arranged on the side of the auxiliary transport means, as described in relation to the first embodiment.

A number of modes of use are thus realized by separating the lower rollers from the upper layer of rollers. The auxiliary transport means is used as a roller track for carrying cargo onto the loading platform, but also as transport means for displacing the whole unloading unit including cargo. The products can also be unloaded according to the known principle, with the two rollers one above the other, whereby the total speed is zero.

1. Loading device for transferring a cargo onto a mobile loading floor, comprising: a frame having a carrying surface wherein the carrying surface has a longitudinal direction and wherein the frame is also provided with support means for supporting the loading device on a ground surface, the loading device being provided with adjusting means for aligning an outer end in the longitudinal direction of the carrying surface.

2. Loading device as claimed in claim 1, wherein the adjusting means comprise tilting means for tilting the carrying surface around at least one tilting axis.

3. Loading device as claimed in claim 2, wherein the tilting axis is substantially the longitudinal direction of the carrying surface.

4. Loading device as claimed in claim 2, wherein the tilting means are formed by the support means.

5. Loading device as claimed in claim 1, wherein the adjusting means comprise sliding means for moving the carrying surface in a plane.

6. Loading device as claimed in claim 5, wherein the sliding means comprise two plates, wherein the plates engage movably on each other by means of a dovetail coupling.

7. Loading device as claimed in claim 1, wherein the adjusting means are adapted for a height adjustment of the carrying surface relative to the ground surface.

8. Loading device as claimed in claim 1, wherein the adjusting means are modified to rotate the carrying surface in a plane.

9. Loading device as claimed in claim 1, wherein the adjusting means are adapted to hold the carrying surface substantially horizontal.

10. Loading device as claimed in claim 1, wherein the adjusting means comprise a cylinder as driving means for the adjustment.

11. Loading device as claimed in claim 1, wherein the loading device further comprises an auxiliary transport means for loading the mobile loading floor, wherein the auxiliary transport means is movable over the carrying surface, and wherein the auxiliary transport means is provided with a number of roller elements and with support means for supporting the load.

12. Loading device as claimed in claim 11, wherein the auxiliary transport means has moving means for moving the auxiliary transport means over the carrying surface, and the auxiliary transport means comprises a number of first roller elements arranged at a regular mutual distance for supporting a load which can be placed on the auxiliary transport means, and a number of second roller elements arranged at a regular mutual distance for displacing the auxiliary transport means over the carrying surface, wherein in a first mode the first roller elements are coupled to the moving means and in a second mode the second roller elements are disengaged.

13. Loading device as claimed in claim 12, wherein in the first mode the first roller elements engage on the second roller elements, and in a second mode the second roller elements are disengaged from the first roller elements.

14. Loading device as claimed in claim 12, wherein the moving means comprise a number of wheels which are bearing-mounted for substantially vertical movement on the auxiliary transport means.

15. Loading device as claimed in claim 1, wherein the loading device comprises coupling means for coupling the loading device to the mobile loading floor.

16. Loading device as claimed in claim 1, wherein the loading device is provided with detecting means for detecting the surface of the mobile loading floor and with a control device coupled to the detecting means and the adjusting means, wherein the control device is adapted to control the adjusting means such that the carrying surface is aligned with the detected surface.

17. Loading device as claimed in claim 16, wherein the control device is adapted to continuously compare the surface alignment.

18. Loading device as claimed in claim 1, wherein the loading device is provided with a positioning part, wherein the positioning part comprises load support means formed by at least a first sub-frame provided with a number of rollers oriented in a first direction, and a second sub-frame provided with a number of rollers oriented in a second direction, wherein the sub-frames are connected movably to the frame of the loading device.

19. Loading device as claimed in claim 11, wherein the loading device is provided with at least one guide oriented substantially parallel to the longitudinal direction.

20. Loading device as claimed in claim 19, wherein the guide is a gear rack.

21. Loading device as claimed in claim 19, wherein the loading device comprises load displacing means which are displaceable along the carrying surface while engaging on the guide.

22. Loading device as claimed in claim 21, wherein the load displacing means comprise a pivoting pusher.

23. Loading device as claimed in claim 19, wherein the drive means engage on the guide such that the auxiliary transport means is displaceable along the guide.

24. Loading device as claimed in claim 23, wherein the guide is connected to the auxiliary transport means.

25. Auxiliary transport device for loading and unloading cargo in a vehicle, comprising a frame provided with support means for supporting a cargo placeable on the auxiliary transport device and formed by a number of first roller elements arranged at a regular mutual distance, and moving means for moving over a surface, the auxiliary transport device formed by a number of second roller elements arranged at a regular mutual distance and a number of bearing-mounted wheels connected movably to the frame.

26. Auxiliary transport device as claimed in claim 25, wherein the auxiliary transport device has a first mode wherein the first roller elements are coupled to the moving means, and a second mode wherein the first roller elements are disengaged from the moving means.

27. Method for transferring cargo between a mobile loading floor and a loading platform, comprising:
loading the cargo onto an auxiliary transport device;
moving the loaded auxiliary transport device over the loading floor and over a carrying surface of a loading device in a longitudinal direction of said loading floor; and
moving the cargo from or onto the auxiliary transport device onto or from the loading floor, wherein at least one of the loading floor and the carrying surface are tilted for the purpose of aligning the loading floor with the carrying surface.
